(19) United States
(12) Patent Application Publication
(10) Pub. No.: US 2026/0018586 A1
(43) Pub. Date: Jan. 15, 2026

(54) APPARATUS AND METHOD FOR MANUFACTURING ELECTRODE

(71) Applicant: SK On Co., Ltd., Seoul (KR)

(72) Inventors: Jong Beom PARK, Daejeon (KR); Se Young LEE, Daejeon (KR); Seong Yun JEONG, Daejeon (KR); Sang Hyun LEE, Daejeon (KR)

(21) Appl. No.: 19/235,579

(22) Filed: Jun. 12, 2025

(30) Foreign Application Priority Data
Jul. 9, 2024 (KR) 10-2024-0090235
Mar. 25, 2025 (KR) 10-2025-0038291

(51) Int. Cl. H01M 4/04

(52) U.S. Cl. CPC H01M 4/043

(57) ABSTRACT

An apparatus for manufacturing an electrode according to an embodiment of the present disclosure may include: a hopper including an inlet into which an electrode material is input; a support plate including a first hollow portion facing the inlet; a partition member disposed in the first hollow portion and including a second hollow portion into which an open region of a second packaging material wrapping an outside of the first packaging material accommodating the electrode material is inserted; and an actuator provided in the support plate, and adjusting a volume of the second hollow portion by pressurizing or depressurizing the partition member, and the partition member may be formed of an elastic material.

### CROSS-REFERENCE TO RELATED APPLICATION(S)

This patent document claims the priority and benefits of Korean Patent Application Nos. 10-2024-0090235 and 10-2025-0038291 filed on Jul. 9, 2024, and Mar. 25, 2025, the disclosure of which is incorporated herein by reference in its entirety.

### TECHNICAL FIELD

The present disclosure relates to an apparatus and a method for manufacturing an electrode.

### BACKGROUND

Battery cells are widely used in small electronic devices such as mobile phones and laptop computers as well as medium and large mechanical devices such as electric vehicles (EV), and may be charged with electricity and reused.

The electrodes of the battery cell may include a cathode and an anode, and the cathode and the anode may include a cathode plate including a cathode active material and an anode plate including an anode active material, respectively.

A separator may be interposed between the cathode plate and the anode plate, and the cathode plate and the anode plate may be electrically isolated from each other to form an electrode assembly. The electrode assembly may be manufactured in a stack type, a stack-folding type, a winding type, or the like.

The electrode assembly may be stored together with an electrolyte in a case selected according to the intended use, such as a pouch type, square type, or cylindrical type, and the case may be sealed to manufacture a battery cell.

In order to manufacture a battery cell in this manner, electrode manufacturing is required, and a process of processing electrode active materials in powder form is required for electrode manufacturing.

### SUMMARY

According to an aspect of the present disclosure, the efficiency of an electrode manufacturing process may be improved.

Additionally, according to an aspect of the present disclosure, a manufacturing yield (or margin) of an electrode may be increased, and pollution of the manufacturing environment may be prevented.

Additionally, the present disclosure may be widely applied to devices within green technology fields such as solar power generation and wind power generation devices.

Additionally, the present disclosure may be applied to eco-friendly devices such as eco-friendly electric vehicles and hybrid vehicles to ameliorate the effects of climate change by suppressing air pollution and greenhouse gas emissions.

An apparatus for manufacturing an electrode according to an embodiment of the present disclosure may include: a hopper including an inlet into which an electrode material is input; a support plate including a first hollow portion facing the inlet; a partition member disposed in the first hollow portion and including a second hollow portion into which an open region of a second packaging material wrapping an outside of a first packaging material accommodating the electrode material is inserted; and an actuator provided in the support plate, and adjusting a volume of the second hollow portion by pressurizing or depressurizing the partition member, and the partition member may be formed of an elastic material.

In an embodiment, the actuator may include: at least one adjusting handle connected to the partition member and including a region exposed to an outside of the first hollow portion.

In an embodiment, the apparatus for manufacturing an electrode may further include: at least one fixing member fixing at least a portion of the partition member to the support plate.

In an embodiment, the partition member may be formed of a material including a polymer.

In an embodiment, the apparatus for manufacturing an electrode may further include: a sealing portion closely bringing at least a partial region of an open region of the second packaging material extending to the outside of the first hollow portion into contact with the inlet so that an end of the second packaging material is maintained in an open state.

In an embodiment, the sealing portion may include: a sealing plate into which the open region of the second packaging material is inserted, and which includes a third hollow portion facing the inlet; and a driving member moving the sealing plate.

In an embodiment, the sealing plate may further include: at least one pressurizing projection protruding in a direction oriented toward the inlet and pressurizing the second packaging material in a direction oriented toward the inlet.

An apparatus for manufacturing an electrode according to another embodiment of the present disclosure may include: a hopper including an inlet into which an electrode material is input; a support plate including a first hollow portion facing the inlet; a partition member disposed in the first hollow portion and including a second hollow portion into which an open region of a second packaging material wrapping an outside of the first packaging material accommodating the electrode material is inserted; an actuator provided in the support plate, and adjusting a volume of the second hollow portion by pressurizing or depressurizing the partition member; a sealing portion closely bringing at least a partial region of an open region of the second packaging material extending to the outside of the first hollow portion into contact with the inlet so that an end of the second packaging material is maintained in an open state; and a glove box including an accommodation space in which at least one of the inlet, the support plate or the sealing portion is accommodated, and at least one insertion slit into which the open region of the second packaging material is inserted, and the partition member may be formed of an elastic material.

In an embodiment, the apparatus for manufacturing an electrode may further include: a glove box including an accommodation space in which at least one of the inlet, the support plate or the sealing member is accommodated, and at least one insertion slit into which the open region of the second packaging material is inserted.

In an embodiment, the support plate may be fixed to the glove box so that the first hollow portion faces the at least one insertion slit.

In an embodiment, the glove box may further include a door for opening or closing the accommodation space.

In an embodiment, the apparatus for manufacturing an electrode may further include: at least one dust collecting pipe disposed in the accommodation space; and a dust collecting pump connected to the dust collecting pipe.

In an embodiment, the apparatus for manufacturing an electrode may further include: at least one fluid injection pipe in which at least one injection port is disposed in the accommodation space.

In an embodiment, in the at least one fluid injection pipe, the at least one injection port may be disposed adjacently to the door.

In an embodiment, the hopper may further include: a connection pipe connected to the inlet; a storage tank connected to the connection pipe and storing the electrode material; and a filter provided in the connection pipe.

In an embodiment, the filter may have magnetism and may be disposed in a circumferential direction of the connection pipe.

Another aspect of the present disclosure, provided is a method for manufacturing an electrode.

The present disclosure provides a method for manufacturing an electrode by supplying an electrode material to a hopper including an inlet, including: a packaging material sealing operation of opening at least a partial region of a second packaging material wrapping an outside of a first packaging material that accommodates the electrode material, and closely bringing at least a partial region of an open region of the second packaging material into contact with the inlet; a packaging material support operation of adjusting a volume of the open region of the second packaging material by pressurizing or depressurizing the open region of the second packaging material; and a supply operation of cutting the first packaging material inside the second packaging material and supplying the electrode material to the inlet.

In an embodiment, the packaging material support operation may include: a gripping operation of reducing a volume of the open region of the second packaging material by gripping the second packaging material with a partition member formed of an elastic material.

In an embodiment, the method for manufacturing an electrode may further include: a dust collection operation of intaking a material around the inlet before performing the supply operation.

According to an aspect of the present disclosure, the efficiency of an electrode manufacturing process may be improved.

Additionally, according to an aspect of the present disclosure, a manufacturing yield (or margin) of an electrode may be increased, and pollution of the manufacturing environment may be prevented.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles to ameliorate the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a front view schematically illustrating an apparatus for manufacturing an electrode according to an embodiment of the present disclosure.

FIG. 2 is a front view schematically illustrating a state in which an adjusting handle of an apparatus for manufacturing an electrode according embodiment of the present disclosure pressurizes a partition member.

FIG. 3 is a front view schematically illustrating a support plate, a partition member, and an adjusting handle based on another embodiment of the present disclosure.

FIG. 4 is a front view schematically illustrating a pressurized partition member at the same point in time as FIG. 3.

FIG. 5 is a front view schematically illustrating an apparatus for manufacturing an electrode based on another embodiment of the present disclosure.

FIG. 6 is a front view schematically illustrating a sealing plate according to an embodiment of the present disclosure.

FIG. 7 is a front view schematically illustrating an apparatus for manufacturing an electrode based on another embodiment of the present disclosure.

FIG. 8 is a front view schematically illustrating an operating state of an apparatus for manufacturing an electrode illustrated in FIG. 7.

FIG. 9 is a front view schematically illustrating an apparatus for manufacturing an electrode based on another embodiment of the present disclosure.

FIG. 10 is a schematic operation state diagram of an apparatus for manufacturing an electrode based on another embodiment of the present disclosure.

FIG. 11 is a schematic front view of an apparatus for manufacturing an electrode based on another embodiment of the present disclosure.

FIG. 12 is a schematic front view of an apparatus for manufacturing an electrode based on another embodiment of the present disclosure.

FIG. 13 is a schematic front view of an apparatus for manufacturing an electrode based on another embodiment of the present disclosure.

FIG. 14 is a schematic diagram illustrating a method for manufacturing an electrode based on an embodiment of the present disclosure.

FIG. 15 is a schematic diagram illustrating a method for manufacturing an electrode based on another embodiment of the present disclosure.

FIG. 16 is a schematic diagram illustrating a method for manufacturing an electrode based on another embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings. However, this is merely exemplary, and the present disclosure is not limited to the specific embodiments described as examples.

The “embodiments” mentioned below do not necessarily refer to the same embodiments. The specific features, structures, or characteristics may be combined or substituted in any suitable manner consistent with the present disclosure.

Hereinafter, an X-axis illustrated in the drawing is a width direction of an inlet 111 of a hopper 110, a Y-axis is a height direction of the inlet 111 of the hopper 110, and a Z-axis is a width direction of the inlet 111 of the hopper 110. However, these are directions arbitrarily set for convenience of understanding, and the aforementioned directions may be changed.

In the attached drawing, a point at which the X-axis, Y-axis and Z-axis intersect may be an origin point or a zero point. Any region in the attached drawing may be the origin point or the zero point. The X-axis, Y-axis and Z-axis illustrated in the attached drawing are illustrated in a positive (+) direction, and a negative (−) direction based on the origin point or the zero point may be understood as an opposite direction to the positive (+) direction.

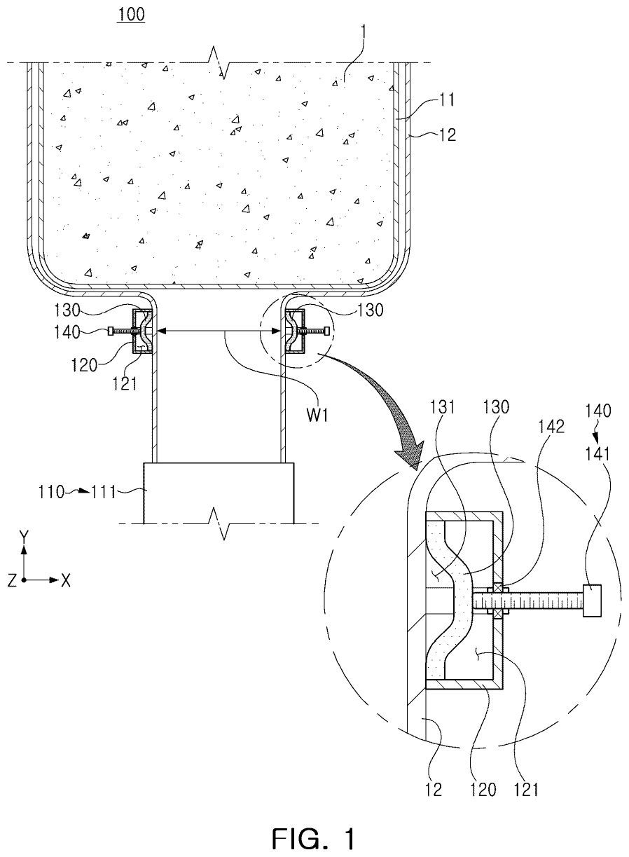

FIG. 1 is a front view schematically illustrating an apparatus 100 for manufacturing an electrode according to an embodiment of the present disclosure. As illustrated in FIG. 1, the apparatus 100 for manufacturing an electrode according to an embodiment of the present disclosure may include a hopper 110 including an inlet 111 into which an electrode material 1 is input, a support plate 120 including a first hollow portion 121 facing the inlet 111, a partition member 130 disposed in the first hollow portion 121 and including a second hollow portion 131 into which an open region of a second packaging material 12 wrapping an outside of a first packaging material 11 accommodating the electrode material 1 is inserted, and an actuator 140 provided in the support plate 120 and adjusting a volume of the second hollow portion 131 by pressurizing or depressurizing the partition member 130.

Additionally, the partition member 130 may be formed of an elastic material.

The electrode material 1 may be in a powder form. The electrode material 1 may include an electrode active material. The electrode active material may be a cathode active material or an anode active material.

The electrode material 1 may be accommodated in the first packaging material 11, and the first packaging material 11 may be accommodated in the second packaging material 12. For example, the electrode material 1 may be accommodated in a ton bag. The first packaging material 11 and the second packaging material 12 may be sealed.

In an embodiment, the first packaging material 11 may be a material including aluminum, and the second packaging material 12 may be a fabric material. Additionally, at least one of the first packaging material 11 and the second packaging material 12 may be a soft material. However, the material of the packaging material may be changed as needed.

The second packaging material 12 accommodating the first packaging material 11 may be transported to a periphery of the hopper 110 by a transporting means, or the like. The transporting means may include a hoist. The transporting means may transport the first packaging material 11 and the second packaging material 12 so that the first packaging material 11 and the second packaging material 12 face the hopper 110 or the inlet 111.

Additionally, in some cases, the transporting means may transport the second packaging material 12 and the first packaging material 11 in a state in which a portion of the second packaging material 12 is cut off. In this case, the open region of the second packaging material 12 may face the hopper 110 or the inlet 111.

Additionally, the transporting means may support the first packaging material 11 and the second packaging material 12 while the electrode material 1 falls into the inlet 111.

The support plate 120 may be fastened to the second packaging material 12. The first hollow portion 121 of the support plate 120 may be a hole formed in the support plate 120. The partition member 130 may be disposed in the first hollow portion 121.

At least a partial region of the partition member 130 may be fixed to the support plate 120 or may be connected to the support plate 120.

The partition member 130 may include a second hollow portion 131. The second hollow portion 131 may be an empty space. In this case, the empty space does not denote a vacuum.

At least a partial region of the second packaging material 12 may be inserted into the second hollow portion 131. In an embodiment, at least a partial region of the second packaging material 12 may be cut to open the second packaging material 12. An open region in the second packaging material 12 may be inserted into the second hollow portion 131.

The open region of the second packaging material 12 may be in contact with at least a partial region of the support plate 120 in the first hollow portion 121 or at least a partial region of the partition member 130. Accordingly, the open region of the second packaging material 12 may be prevented from being excessively widened. This may contribute to preventing the electrode material 1 from being separated from the outside of the second packaging material 12, and preventing the electrode material 1 from scattering.

The open region of the second packaging material 12 may extend in a direction oriented toward the inlet 111. An end of the second packaging material 12 may be in contact with the inlet 111.

The open region of the second packaging material 12 may be a skirt. For example, the skirt may serve to guide the electrode material 1 to the inlet 111, and may serve to prevent or minimize the electrode material 1 from escaping outside the inlet 111, and may block foreign substances other than the electrode material 1 from being introduced into the inlet 111.

In an embodiment, the actuator 140 may include at least one adjusting handle 141 connected to the partition member 130 and including a region exposed to the outside of the first hollow portion 121.

In an embodiment, the at least one adjusting handle 141 may include a plurality of adjusting handles 141. An outer surface of the adjusting handle 141 may be provided with screw threads, and a bearing 142 may be provided between the adjusting handle 141 and the support plate 120.

The adjusting handle 141 may be rotated by an operator or an automated device such as a robot arm. When the adjusting handle 141 rotates clockwise, the adjusting handle 141 may be moved in a direction approaching the first hollow portion 121 or a direction oriented toward the first hollow portion 121.

When the adjusting handle 141 rotates counterclockwise, the adjusting handle 141 may be moved in an opposite direction to the first hollow portion 121 or a direction away from the first hollow portion 121. However, a direction of movement of the adjusting handle 141 according to the rotation direction may be changed.

The bearing 142 may prevent interference between the support plate 120 and the adjusting handle 141 when the adjusting handle 141 rotates.

At least a portion of the adjusting handle 141 may be in contact with the partition member 130. The adjusting handle 141 may be moved in the direction oriented toward the first hollow portion 121 or in the direction approaching the first hollow portion 121, so that the partition member 130 may be moved in a direction oriented toward the second packaging material 12 or in a direction approaching the second packaging material 12.

When the adjusting handle 141 is moved in the direction oriented toward the first hollow portion 121 or in the direction approaching the first hollow portion 121, the partition member 130 may be pressurized.

The adjusting handle 141 may be moved in the opposite direction to the first hollow portion 121 or in the direction away from the first hollow portion 121, so that the pressurization of the partition member 130 may be released.

The second packaging material 12 prior to being pressurized by the partition member 130 may have a first width W1. The first width W1 may be a width or a diameter of the open region of the second packaging material 12 or a region acting as a skirt in the second packaging material 12.

In this case, the first width W1 may be a maximum width or a maximum diameter of the open region of the second packaging material 12 or the region acting as the skirt in the second packaging material 12.

For example, when the open region of the second packaging material 12 or the region acting as the skirt in the second packaging material 12 is crumpled or wrinkled to have a plurality of width values in an X-Z plane, the first width W1 may be a maximum width or a maximum diameter of the open region of the second packaging material 12 or the region acting as the skirt in the second packaging material 12.

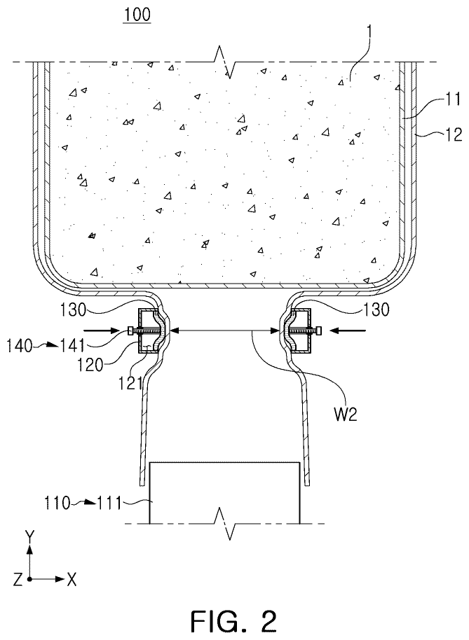

FIG. 2 schematically illustrates a state in which the adjusting handle 141 of the apparatus 100 for manufacturing an electrode according to an embodiment of the present disclosure pressurizes the partition member 130. As shown in FIG. 1 and FIG. 2, the partition member 130 pressurized by the plurality of adjusting handles 141 may pressurize the second packaging material 12. Conversely, the partition member 130 whose pressurization by the adjusting handle 141 is released may release the pressurization of the second packaging material 12.

The partition member 130 may be formed of an elastic material as described above. In an embodiment, the partition member 130 may be formed of a material including a polymer. For example, the partition member 130 may be a material including rubber, and the like. An elastic coefficient of the partition member 130 may be appropriately set to be suitable for a material, specifications, and the like, of the second packaging material 12, and a numerical value is not necessarily limited by the present disclosure.

The partition member 130 may have a bent shape in a cross-section (X-Y plane) of the second packaging material 12 in a thickness direction. For example, the partition member 130 may include a region having a shape such as ‘]’, ‘[’, ‘(’, ‘).’

Additionally, the partition member 130 may have an appropriate thickness in the cross-section (X-Y plane) of the second packaging material 12 in the thickness direction.

For example, at least a partial region of the partition member 130 prior to pressurizing the second packaging material 12 may have a shape of ‘).’ The adjusting handle 141 may pressurize a region having the shape of ‘)’ in the partition member 130, and thus, the shape of the partition member 130 may be transformed into ‘(’ and a region of the partition member 130 in which the shape is transformed may simultaneously pressurize the second packaging material 12.

Conversely, when the adjusting handle 141 is moved to a region away from the partition member 130, the partition member 130 may be restored to a shape before pressurizing the second packaging material 12 by own elasticity thereof.

Alternatively, in the case in which the adjusting handle 141 is fixed to the partition member 130 by an adhesive or the like, when the adjusting handle 141 moves in a direction away from the second packaging material 12, the partition member 130 may be pulled and moved in the direction away from the second packaging material 12 by the adjusting handle 141. This is not necessarily limited by the present disclosure.

Additionally, in the embodiment, the support plate 120 may include a diaphragm valve or an IRIS valve. In this case, the second packaging material 12 may be compressed or spread by the diaphragm valve or the IRIS valve.

By adjusting a width, a volume, an area, and the like, of the open region in the second packaging material 12, the supply amount of the electrode material 1 to the hopper 110, the supply speed of the electrode material 1, and the like, may be appropriately adjusted.

Meanwhile, a width of the second packaging material 12 pressurized by the partition member 130 may be a second width W2. The second width W2 may have a smaller value than a first width W1. The second width W2 may be a width of a region of the second packaging material 12 that had the first width W1 before being pressurized by the partition member 130. For example, in the above-described content, it may be understood that a region that had the first width W1 before being pressurized by the partition member 130 is pressurized by the partition member 130 and is shrunk or contracted to have the second width W2.

As a width of the second packaging material 12 may be varied by the partition member 130 in this manner, a volume of a space in which the electrode material 1 moves to the inlet 111 may be adjusted. Accordingly, an appropriate second width W2 may be set by considering the characteristics of the electrode material 1, the supply amount of the electrode material 1, the falling speed of the electrode material 1, and the like.

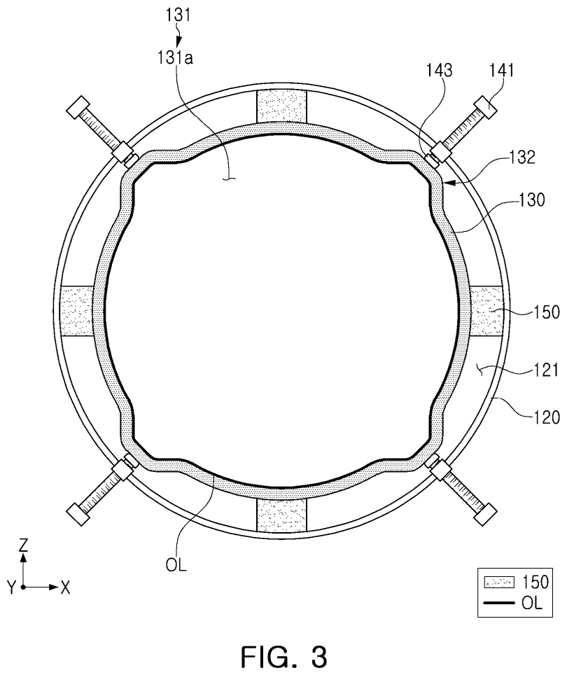

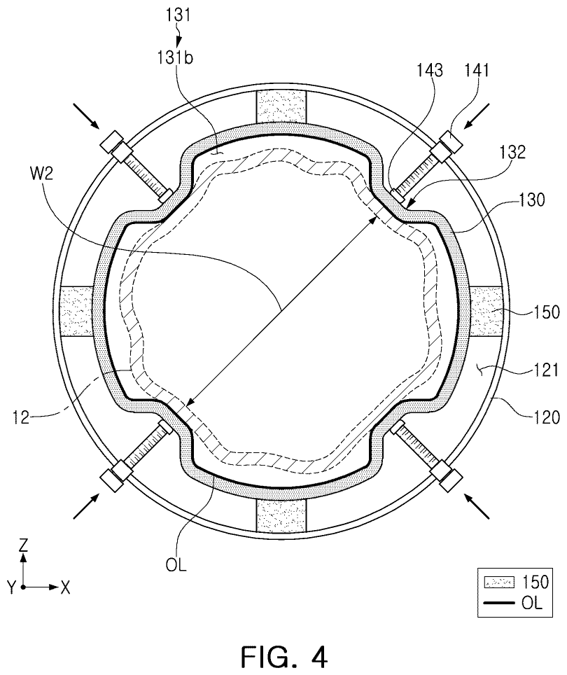

FIG. 3 is a schematic plan view of a support plate 120, a partition member 130, and an adjusting handle 141 based on another embodiment of the present disclosure, and FIG. 4 schematically illustrates a pressurized partition member 130 at the same point in time as FIG. 3.

As shown in FIGS. 3 and 4, in an embodiment of the present disclosure, the apparatus 100 for manufacturing an electrode may further include at least one fixing member 150 fixing at least a partial region of the partition member 130 to the support plate 120.

The at least one fixing member 150 may include a plurality of fixing members 150. The plurality of fixing members 150 may be disposed in the first hollow portion 121. The plurality of fixing members 150 may be spaced apart from each other by a predetermined distance in a circumferential direction of the partition member 130.

One surface of the fixing member 150 may be fixed to the support plate 120, and the other surface of the fixing member 150 may be fixed to the partition member 130. A task for fixing the fixing member 150 may be performed using an adhesive, tape, or the like, but a fixing method is not limited by the present disclosure.

The fixing member 150 may be in contact with a region of the partition member 130 that does not contact the adjusting handle 141. Additionally, the fixing member 150 may fix a region in contact with the partition member 130 to the partition member 130.

A volume of the second hollow portion 131 may have a first volume 131a before the partition member 130 is pressurized by the adjusting handle 141, and may have a second volume 131b after the partition member 130 has been pressurized by the adjusting handle 141. A value of the first volume 131a may be greater than a value of the second volume 131b.

However, since FIGS. 3 and 4 are plan views, the first volume 131a of the second hollow portion 131 may be understood as a first area of the second hollow portion 131, and the second volume 131b of the second hollow portion 131 may be understood as a second area of the second hollow portion 131. In this case, a value of the first width may be greater than a value of the second width.

In an embodiment, the partition member 130 may include a deformation region 132 that is a bent region or a region having a shape such as ‘],’ ‘[’ ‘(,’ and ‘).’ The adjusting handle 141 may pressurize the deformation region 132.

In an embodiment, a pressurization portion 143, which is an end of the adjusting handle 141, may be in contact with the deformation region 132, and may pressurize the deformation region 132. In some cases, the pressurization portion 143 may be further provided with a buffer material, or the like.

As the adjusting handle 141 enters the first hollow portion 121, the partition member 130 may move in a direction closer to the second packaging material 12. When the pressurization of the partition member 130 by the adjusting handle 141 is completed, a bent region in the partition member 130 or the deformation region 132 may have a shape inverted with respect to a shape before being pressurized by the adjusting handle 141. For example, the deformation region 132 may have a shape inverted in a reverse direction from the shape before being pressurized by the adjusting handle 141 after being pressurized by the adjusting handle 141.

An outer line OL of the partition member 130 may have different shapes before being pressurized by the adjusting handle 141 and at the time when the pressurization by the adjusting handle 141 is completed.

In an embodiment, the partition member 130 may be disposed continuously in a circumferential direction of the second packaging material 12.

The partition member 130 may be provided in a shape of a ring in which a center thereof is empty. An empty region in the partition member 130 may be the second hollow portion 131. For example, the partition member 130 may include a hollow portion in a cross-section (X-Z plane) of the inlet 111 in a width direction, and the hollow portion may be an empty space. The hollow portion may be a second hollow portion 131. Additionally, the partition member 130 may have a certain thickness in the cross-section (X-Z plane) in the width direction.

The second packaging material 12 may be inserted into the second hollow portion 131, and the second packaging material 12 may be pressurized by the partition member 130 in the second hollow portion 131.

The first hollow portion 121 and the second hollow portion 131 may overlap each other in a Y-direction. The second hollow portion 131 may be disposed in the first hollow portion 121.

A region having the second width W2 in the second packaging material 12 that has been pressurized by the partition member 130 may be a region that had the first width W1 initially, i.e., before being pressurized by the partition member 130.

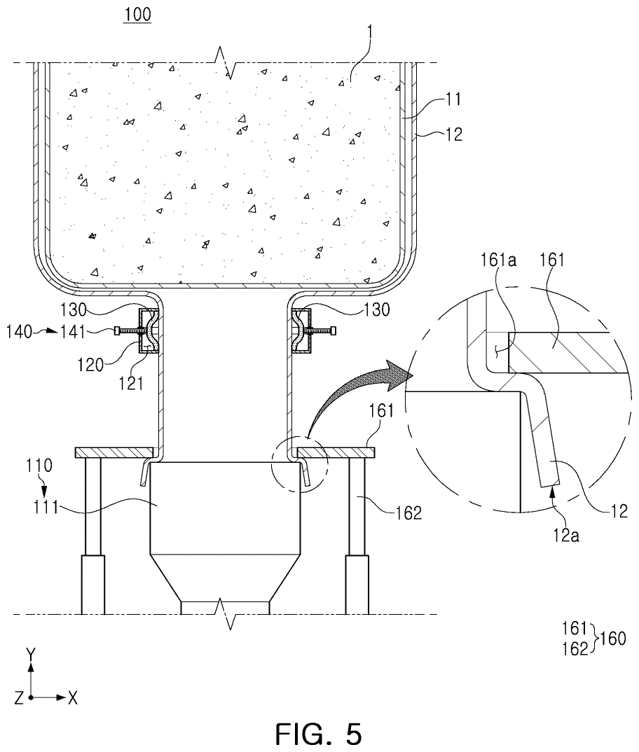

FIG. 5 is a schematic front view of an apparatus 100 for manufacturing an electrode based on another embodiment of the present disclosure. As shown in FIG. 5, in an embodiment of the present disclosure, the apparatus 100 for manufacturing an electrode may further include a sealing portion 160 that closely brings at least a partial region of the open region of the second packaging material 12 extending outside the first hollow portion 121 into contact with the inlet 111 so that an end 12a of the second packaging material 12 is maintained in an open state.

At least a partial region of the open regions in the second packaging material 12 may extend to the outside of the support plate 120 and may be exposed to the outside of the support plate 120. For example, at least a partial region of the open regions in the second packaging material 12 may extend in a −Y-direction from the first hollow portion 121 and may be exposed in the −Y-direction from the first hollow portion 121. In this case, at least a partial region of the open regions in the second packaging material 12 may include the end 12a of the second packaging material 12.

In an embodiment, the open region in the second packaging material 12 may include the end 12a of the second packaging material 12 and a region acting as a skirt in the second packaging material 12.

In an embodiment, the sealing portion 160 may include a sealing plate 161 including a third hollow portion 161a into which the open region of the second packaging material 12 is inserted and which faces the inlet 111, and a driving member 162 moving the sealing plate 161.

The sealing portion 160 may seal the outside of the inlet 111, a periphery of the inlet 111, and the like, with the second packaging material 12, thus preventing the electrode material 1 from scattering the outside of the inlet 111 or the outside of the second packaging material 12. That is, the sealing portion 160 may ensure an entire amount of the electrode material 1 to be supplied to the inlet 111 to be supplied to the inlet 111.

In an embodiment, the sealing member 160 may closely bring the second packaging material 12 into contact with the inlet 111, and may wrap an outer surface of the inlet 111 with the second packaging material 12 so that the entire amount of the electrode material 1 supplied or dropped from the first packaging material 11 opened later may be supplied to the inlet 111. The first packaging material 11 may be disposed above the inlet 111, and thus, when the first packaging material 11 is opened, the electrode material 1 may fall toward the inlet 111.

In an embodiment, the sealing member 160 may further include a close contact plate or a pressurization plate which closely brings or pressurizes the second packaging material 12 into contact with the inlet 111.

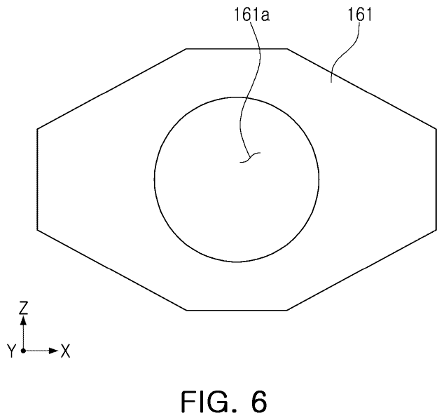

FIG. 6 is a plan view schematically illustrating a sealing plate 161 based on an embodiment of the present disclosure. As shown in FIGS. 5 and 6, the sealing plate 161 may include a third hollow portion 161a into which the open region of the second packaging material 12 is inserted, and the third hollow portion 161a may be a hole formed in the sealing plate 161.

The second packaging material 12 may be inserted into the third hollow portion 161a, and the end 12a of the second packaging material 12 passing through the third hollow portion 161a may be opened in a direction oriented toward the outer line of the inlet 111. The end 12a of the second packaging material 12 may be opened toward a side surface of the inlet 111 so as not to close an upper portion (upper portion in the +Y direction) of the inlet 111.

The sealing plate 161 may be connected to the driving member 162, and the driving member 162 may move the sealing plate 161. The driving member 162 may provide power to the sealing plate 161. The driving member 162 may move the sealing plate 161 in a direction that is parallel to the Y-axis.

For example, the driving member 162 may be implemented in various manners, such as combinations of a pneumatic cylinder, a hydraulic cylinder, a robot arm, a linear motion structure, a motor, and a gear. The sealing plate 161 may be moved in the +Y direction and the −Y direction by the driving member 162.

The sealing plate 161 may pressurize the second packaging material 12 in a direction oriented toward the inlet 111 in a state in which the second packaging material 12 is opened toward the outside of the inlet 111. At least a partial region of the open regions in the second packaging material 12 may be interposed between the sealing plate 161 and the inlet 111. For example, a region acting as a skirt in the second packaging material 12 may be interposed between the sealing plate 161 and the inlet 111, and may be pressurized by the sealing plate 161 and the inlet 111. Accordingly, the open region of the second packaging material 12 may be fixed.

As the open region of the second packaging material 12 is fixed, the region acting as a skirt in the second packaging material 12 may also be fixed. Accordingly, when the electrode material 1 falls toward the inlet 111, the electrode material 1 may be prevented from scattering to the outside of the second packaging material 12 and the outside of the inlet 111. This may contribute to preventing unnecessary consumption of electrode material 1, and may contribute to increasing the manufacturing yield of the electrode.

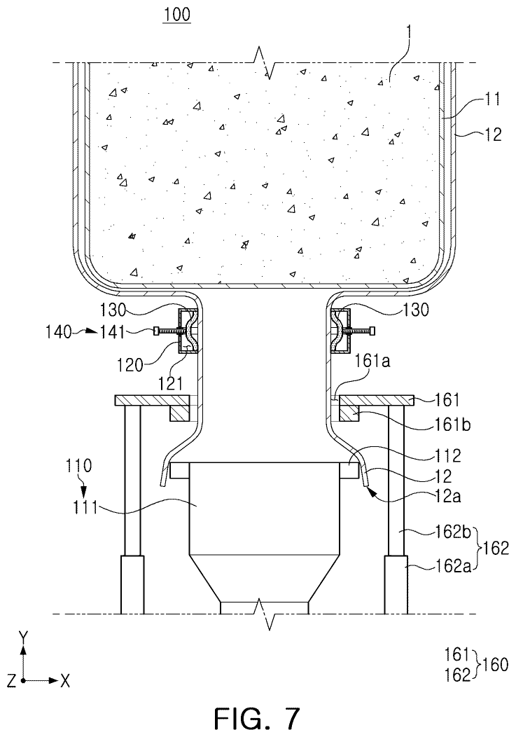

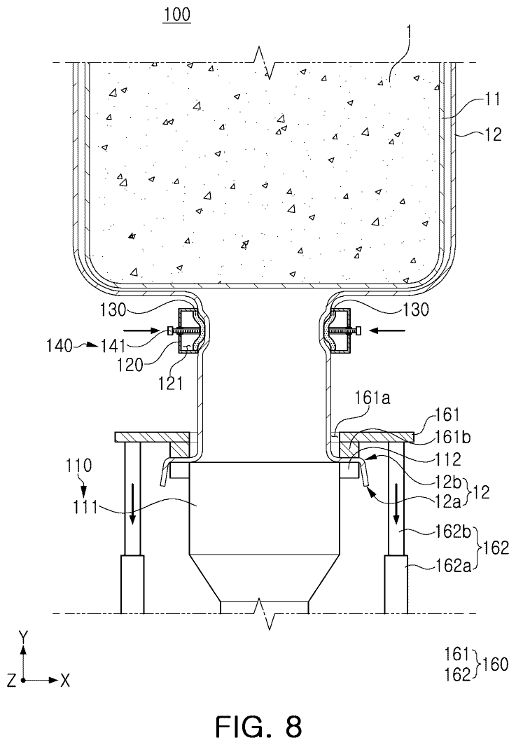

FIG. 7 is a schematic front view of an apparatus 100 for manufacturing an electrode based on another embodiment of the present disclosure, and FIG. 8 is a schematic operating state diagram of the apparatus 100 for manufacturing an electrode illustrated in FIG. 7. As shown in FIGS. 7 and 8, in an embodiment of the present disclosure, the sealing plate 161 may include at least one pressurizing projection 161b protruding in a direction oriented toward the inlet 111 and pressurizing the second packaging material 12 in a direction oriented toward the inlet 111. The at least one pressurizing projection 161b may include a plurality of pressurizing projections 161b.

The pressurizing projection 161b may protrude from a surface of the sealing plate 161 on which the sealing plate 161 faces the inlet 111.

In an embodiment, a friction-reducing member, and the like, may be provided on a surface on which the pressurizing projection 161b is in contact with the second packaging material 12. Accordingly, the second packaging material 12 may be prevented from being unnecessarily separated from the sealing plate 161 or from slipping from the sealing plate 161.

Additionally, in an embodiment, the inlet 111 may be provided with a protrusion portion 112 corresponding to the pressurizing projection 161b. The protrusion portion 112 may be a region in which the inlet 111 protrudes relatively more in a width direction or a diameter direction of the hopper 110.

At least a partial region of the protrusion portion 112 and at least a partial region of the pressure projection 161b may overlap each other in a height direction (Y-direction) of the inlet 111. Accordingly, the second packaging material 12 may be pressurized by the pressure projection 161b and the protrusion portion 112, and may prevent the end 12a of the second packaging material 12 from being excessively widened.

The second packaging material 12 may be pressurized by the pressure projection 161b and the protrusion portion 112. A region of the second packaging material 12 that is pressurized and bent by the pressure projection 161b and the protrusion portion 112 may be a bent region 12b.

The driving member 162 may move the sealing plate 161 in the direction oriented toward the protrusion portion 112. Additionally, the driving member 162 may move the sealing plate 161 in a direction away from the protrusion portion 112.

In an embodiment, the driving member 162 may include a cylinder. The driving member 162 may include a body 162a and a piston rod 162b in which a length thereof is extended or contracted in the body 162a.

The piston rod 162b may be connected to the sealing plate 161 and may move the sealing plate 161. In an embodiment, the driving member 162 may be provided in plural, but this is not necessarily limited by the present disclosure.

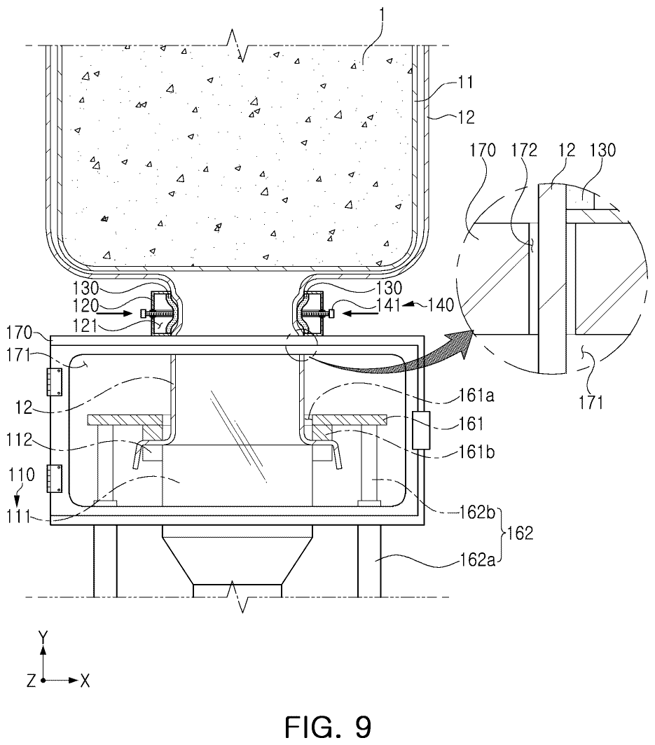

FIG. 9 is a schematic front view of an apparatus 100 for manufacturing an electrode based on another embodiment of the present disclosure. As shown in FIG. 9, the apparatus 100 for manufacturing an electrode may include a hopper 110 including an inlet 111 into which an electrode material is input, a support plate 120 including a first hollow portion 121 facing the inlet, a partition member 130 disposed in the first hollow portion and including a second hollow portion 131 into which an open region of a second packaging material wrapping the outside of a first packaging material accommodating the electrode material is inserted, an actuator 140 provided in the support plate and adjusting a volume of the second hollow portion by pressurizing or depressurizing the partition member, a sealing member 160 closely bringing at least a partial region of the open region of the second packaging material extending outside the first hollow portion into contact with the inlet so that an end of the second packaging material is maintained in an open state, and a glove box 170 including an accommodation space 171 in which at least one of the inlet or the sealing portion is accommodated and at least one insertion slit 172 into which the open region of the second packaging material is inserted, and the partition member 130 may be formed of an elastic material.

In an embodiment of the present disclosure, the apparatus 100 for manufacturing an electrode may further include a glove box 170 including an accommodation space 171 in which at least one of the inlet 111, the support plate 120 or the sealing portion 160 is accommodated, and at least one insertion slit 172 in which the open region of the second packaging material 12 is inserted.

In an embodiment, the accommodation space 171 may accommodate the open region of the second packaging material 12, the sealing plate 161, and at least a partial region of the driving member 162. The glove box 170 may include an area made of a transparent material. Accordingly, a state of the inlet 111, a state of the second packaging material 12, and the like, may be visually confirmed from the outside of the glove box 170.

The glove box 170 may include a through-hole and a groove for assembly so that components accommodated in the accommodation space 171 may be easily disposed in the accommodation space 171.

The glove box 170 may be provided to separate the accommodation space 171 from the outside of the glove box 170.

In an embodiment, the at least one insertion slit 172 may include a plurality of insertion slits 172. The plurality of insertion slits 172 may be spaced apart from each other, and the open region of the second packaging material 12 may penetrate therethrough.

The open region of the second packaging material 12 passing through the plurality of insertion slits 172 and the end 12a of the second packaging material 12 may be disposed in the accommodation space 171. In some cases, the insertion slits 172 may be replaced with holes formed in the glove box 170.

According to the glove box 170, it may be possible to more effectively prevent the electrode material 1 from scattering to the inlet 111 or prevent task environments from being polluted. Additionally, it may be possible to prevent the components of the apparatus 100 for manufacturing an electrode from being damaged or broken by external environments.

In an embodiment, the support plate 120 may be fixed to the glove box 170 so that the first hollow portion 121 faces the at least one insertion slit 172. For example, the support plate 120 may be fixed to an upper portion (upper portion in the +Y direction) of the glove box 170. Accordingly, the open region of the second packaging material 12 may pass through the first hollow portion 121 and then through the insertion slit 172 to be disposed in the accommodation space 171.

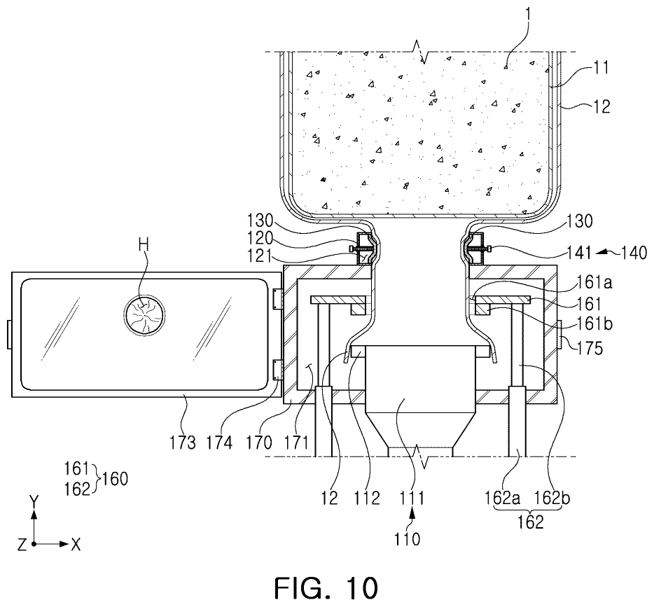

FIG. 10 is a schematic operation state diagram of an apparatus 100 for manufacturing an electrode based on another embodiment of the present disclosure. As shown in FIG. 10, in an embodiment of the present disclosure, the glove box 170 may include a door 173 for opening or closing the accommodation space 171.

In an embodiment, the door 173 includes a glove box 170 and a coupling portion 174, and the coupling portion 174 may include a hinge. Accordingly, an operator may easily perform tasks of cutting the first packaging material 11 and the second packaging material 12, or widening a cut region or the open region of the second packaging material 12 to cover the outside of the inlet 111 therewith. Accordingly, the electrode manufacturing efficiency may be improved, and the convenience of maintenance of the device may be improved.

In an embodiment, the glove box 170 may further include a locking member 175. The locking member 175 may perform a locking function of the door 173 and prevent the door 173 from being opened in an unnecessary situation. For example, the locking member 175 may include an interlock device.

In an embodiment, the door 173 may include a region formed of a transparent material. Accordingly, an interior of the accommodation space 171 may be monitored even when the door 173 is closed.

Additionally, in an embodiment, an input hole H may be added to the glove box 170 or the door 173. The input hole H may be a hole formed in the glove box 170 or the door 173.

In this case, the operator's hand or a robot arm may enter the accommodation space 171 through the input hole H. Accordingly, a supply task of the electrode material 1 may be performed even when the door 173 is closed.

Additionally, in an embodiment, the input hole H may be further provided with a rubber glove, an injection skirt, a sealing member, and the like. Accordingly, foreign substances may be prevented from being mixed into the interior of the glove box 170.

In some cases, the input hole H may be further provided with a sealing curtain, and the like. Additionally, the input hole H may be provided in plural.

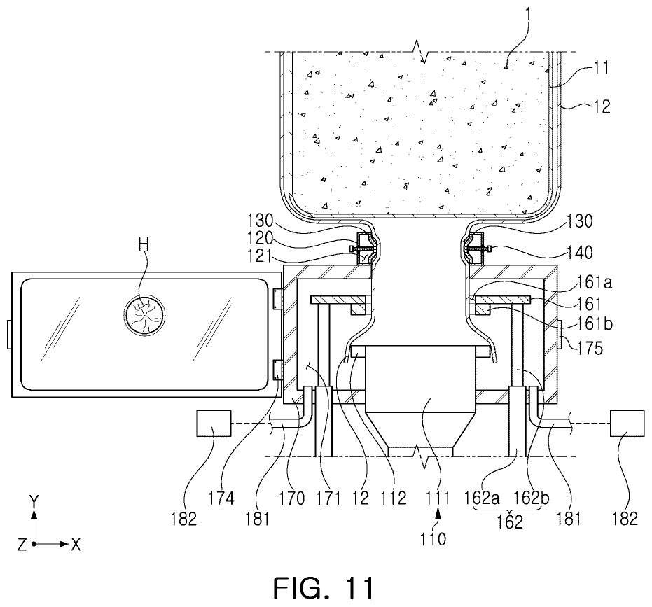

FIG. 11 is a schematic front view of an apparatus 100 for manufacturing an electrode according to another embodiment of the present disclosure. As shown in FIG. 11, in an embodiment of the present disclosure, the apparatus 100 for manufacturing an electrode may further include at least one dust collecting pipe 181 disposed in the accommodation space 171 and a dust collecting pump 182 connected to the dust collecting pipe 181. An intake port of the dust collecting pipe 181 may be disposed in the accommodation space 171.

At least one dust collecting pipe 181 may include a plurality of dust collecting pipes 181. The dust collector 181 may be provided with a tube, hose, pipe, and the like. The dust collector pump 182 may be connected to the dust collector 181.

Accordingly, by controlling an operation of the dust collector pump 182, a material scattering into the accommodation space 171 may be intaken. In this case, since the inlet 111 is sealed or sealed by the second packaging material 12, the electrode material 1 normally input into the inlet 111 may not be intaken into the intake port of the dust collector 181.

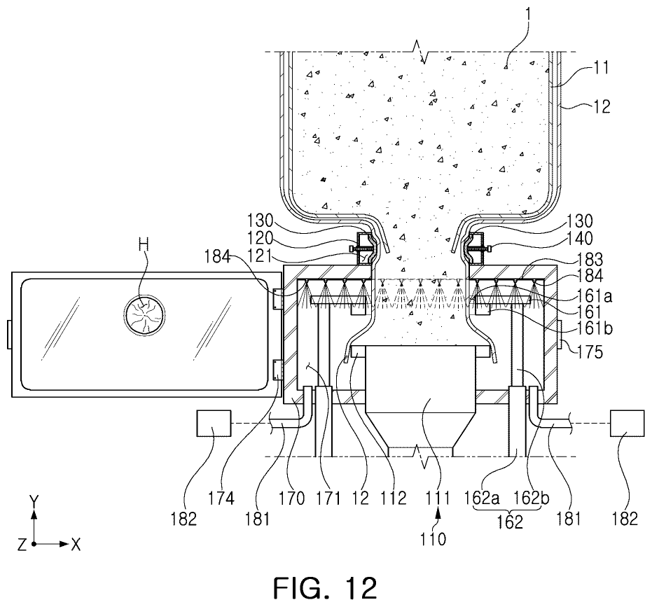

FIG. 12 is a schematic front view of an apparatus 100 for manufacturing an electrode based on another embodiment of the present disclosure. As shown in FIG. 12, in an embodiment of the present disclosure, the apparatus 100 for manufacturing an electrode may further include at least one fluid injection pipe 183 in which at least one injection port 184 is disposed in the accommodation space 171.

The fluid injection pipe 183 may be provided in a position adjacent to the door 173 and may be fixed to the glove box 170. The fluid injection pipe 183 may be connected to a fluid supply tank, a pump for providing pressure, and the like.

At least one injection port 184 may include a plurality of injection ports 184. The plurality of injection ports 184 may be passages through which the fluid contained in the fluid supply tank is ejected. For example, a fluid may include air, but the type of the fluid is not limited by the present disclosure.

In an embodiment, the plurality of injection ports 184 may be disposed adjacently to the door 173. For example, the plurality of injection ports 184 may be disposed in parallel along the door 173. The plurality of injection ports 184 may function as an air curtain. Accordingly, it may be possible to prevent or minimize foreign substances from being exposed to the outside of the glove box 170 through the door 173.

As above, by spraying the fluid at high pressure through the plurality of injection ports 184, it may be possible to prevent or minimize foreign substances floating inside the accommodation space 171 from being discharged to the outside of the glove box 170.

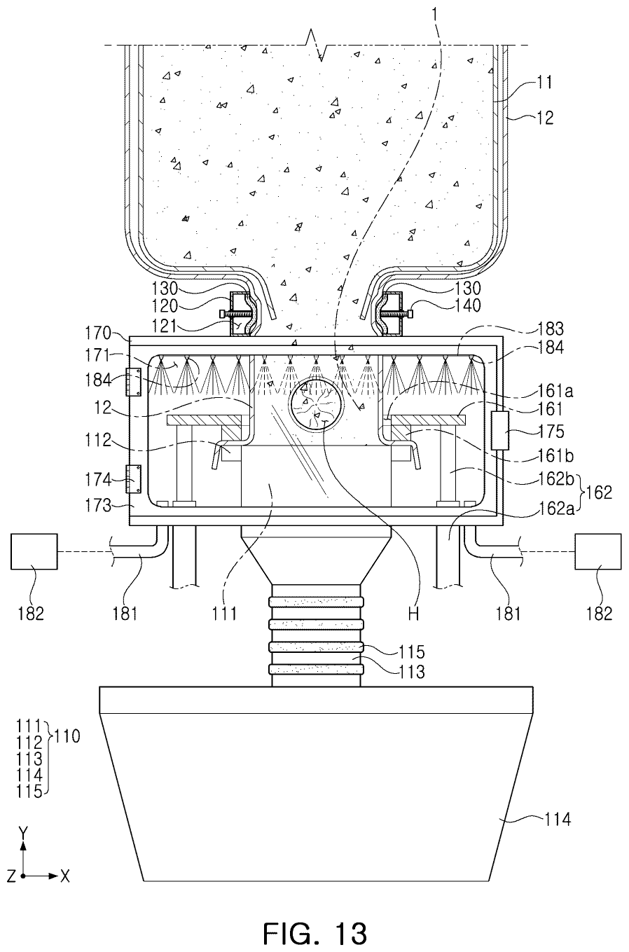

FIG. 13 is a schematic front view of an apparatus 100 for manufacturing an electrode according to another embodiment of the present disclosure. As shown in FIG. 13, in an embodiment of the present disclosure, the hopper 110 may further include a connection pipe 113 connected to the inlet 111, a storage tank 114 connected to the connection pipe 113 and storing the electrode material 1, and a filter 115 provided in the connection pipe 113.

The connection pipe 113 may be disposed in a lower portion (or a lower portion in the −Y-direction) of the inlet 111 and may be connected to the inlet 111. The connection pipe 113 may be provided with a tube, a pipe, a hose, and the like. The connection pipe 113 may connect the inlet 111 and the storage tank 114. A certain amount of electrode material 1 may be stored in the storage tank 114.

The operator may transport the first packaging material 11 and the second packaging material 12 around the glove box 170 by means of a transport means in a state in which at least a partial region of the second packaging material 12 is cut.

The open region of the second packaging material 12 may pass through the first hollow portion 121 and the insertion slit 172 and may be disposed in the accommodation space 171. In this case, the second packaging material 12 may also be disposed inside the second hollow portion 131. In a state in which the door 173 is open, the open region of the second packaging material 12 may be widened to cover the outer surface of the inlet 111 therewith.

Accordingly, the adjusting handle 141 may be manipulated to pressurize the second packaging material 12 through the partition member 130. Then, the second packaging material 12 disposed in the first hollow portion 121 or the second hollow portion 131 may be partially compressed, and a width, a volume, an area, and the like, of a region that becomes a passage through which the electrode material 1 moves in the second packaging material 12 may be reduced by a certain level. Accordingly, a supply amount, supply speed, and the like, of the electrode material 1 may be primarily adjusted.

Then, the operator may drive the driving member 162 to descend the sealing plate 161. In this case, the second packaging material 12 may be pressurized and fixed by the sealing plate 161 and the inlet 111. Then, the operator may cut the first packaging material 11. Accordingly, the electrode material 1 may fall into the accommodation space 171 and may be input into the inlet 111. The electrode material 1 passing through the inlet 111 may be stored in a certain amount in the storage tank 114.

If necessary, dust collection and foreign substance removal tasks may be performed using the dust collection pipe 181 and the fluid injection pipe 183.

In an embodiment, the filter 115 may have magnetism and may be disposed in a circumferential direction of the connection pipe 113. The filter 115 may include a magnetic body. The filter 115 may filter a material having magnetism in the electrode material 1 or foreign substances passing through the connecting tube 113. Accordingly, the material having magnetism in the connecting tube 113 may be attacked to an inner wall of the connecting tube 113. IN this case, the material attacked to the inner wall of the connecting tube 113 may also be collected. However, this is not limited by the present disclosure.

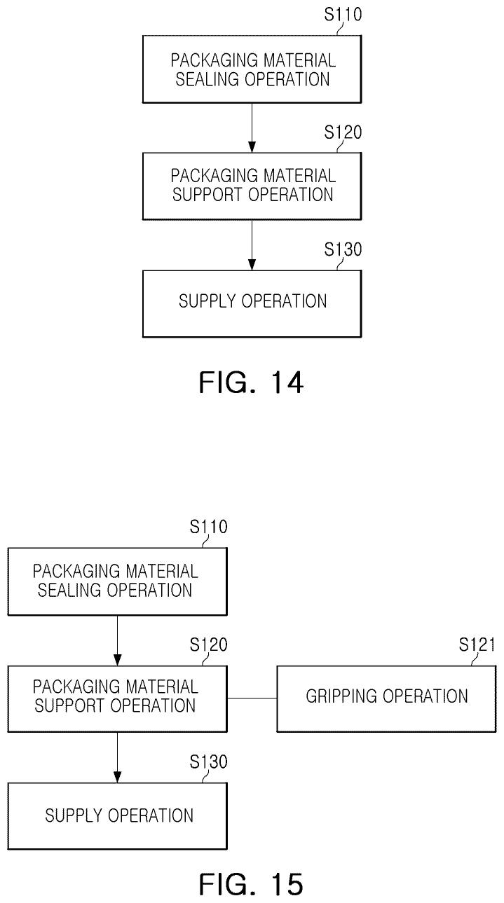

On the other hand, the present disclosure as another aspect provides a method for manufacturing an electrode by supplying an electrode material 1 to a hopper 110 including an inlet 111. FIG. 14 schematically illustrates a method for manufacturing an electrode based on an embodiment of the present disclosure.

As shown in FIGS. 1 to 14, the method for manufacturing an electrode according to an embodiment of the present disclosure may include a packaging material sealing operation (S110) of opening at least a partial region of a second packaging material 12 wrapping an outside of a first packaging material 11 that accommodates the electrode material 1 and closely bringing at least a partial region of an open region of the second packaging material 12 into contact with the inlet 111, a packaging material support operation (S120) of adjusting a volume of an open area of the second packaging material 12 by pressurizing or depressurizing the open area of the second packaging material 12, and a supply operation (S130) of cutting the first packaging material 11 inside the second packaging material 12 and supplying the electrode material 1 to the inlet 111.

The packaging material sealing operation (S110) may include a process of cutting at least a portion of the second packaging material 12 and inserting the same into the first hollow portion 121 or the second hollow portion 131.

The packaging material sealing operation (S110) may include a process of fixing the second packaging material 12 by pressurizing the open portion of the second packaging material 12 with the sealing plate 161 and the inlet 111.

The packaging material support operation (S120) may include a process of widening a cut region of the second packaging material 12 or the end 12a of the second packaging material 12 to cover an outer surface of the inlet 111 therewith.

The packaging material sealing operation (S110) and the packaging material support operation (S120) may be performed simultaneously, or either the packaging material sealing step (S110) or the packaging material support operation (S120) may be performed first.

The supply operation (S130) may include a process of cutting the first packaging material 11 with a cutting member including a cutting blade, a cutter, or the like. Then, the electrode material 1 may fall into the inlet 111 of the hopper 110 and may be supplied to the hopper 110.

A transport rail, or the like, may be connected to the hopper 110, and the electrode material 1 may be supplied as a post-electrode process. The post-electrode process may include a mixing process, and a stirring process.

According to an embodiment of the present disclosure, the electrode manufacturing process may be performed continuously, and the electrode manufacturing process may be automated.

FIG. 15 schematically illustrates a method for manufacturing an electrode based on another embodiment of the present disclosure. As shown in FIGS. 1 to 13 and FIG. 15, in an embodiment of the present disclosure, the packaging material support operation (S120) may include a gripping operation (S121) of gripping the second packaging material 12 with a partition member 130 formed of an elastic material to reduce the volume of the open region of the second packaging material 12.

The gripping operation (S121) may include a process of pressurizing the second packaging material 12 with the partition member 130 to reduce a partial region of the second packaging material 12 and preventing the electrode material 1 from unnecessarily scattering within the second packaging material 12.

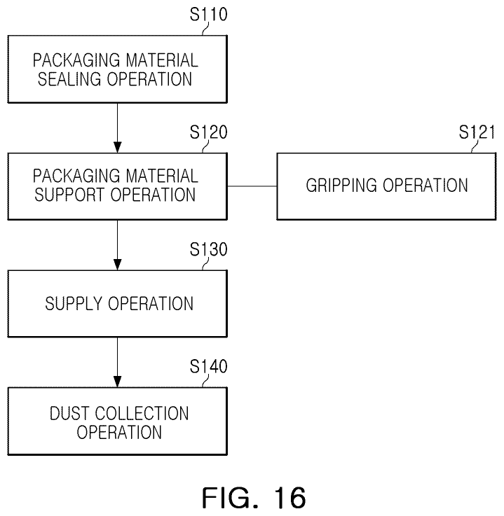

FIG. 16 schematically illustrates a method for manufacturing an electrode based on another embodiment of the present disclosure. As shown in FIGS. 1 to 13 and FIG. 16, in an embodiment of the present disclosure, the method for manufacturing an electrode may further include a dust collection operation (S140) of intaking a material around the inlet 111 before performing the supply operation (S130).

In an embodiment, the dust collection operation (S140) may be performed by a dust collection pipe 181, a dust collection pump 182, or the like. Additionally, the dust collection operation (S140) may be performed during the supply operation (S130) or after the supply operation (S130) is completed.

The apparatus 100 for manufacturing an electrode and the method for manufacturing an electrode as described above may be utilized to supply electrode materials 1 in a powder form, including electrode active materials, binders, conductive materials, and dispersion materials. Additionally, the apparatus 100 for manufacturing an electrode and the method for manufacturing an electrode may be utilized to continuously perform the electrode manufacturing process.

The apparatus 100 for manufacturing an electrode and the method for manufacturing an electrode may be utilized to supply the electrode material 1 of a secondary battery, for example, the electrode material 1 of a lithium ion battery cell, to the hopper 110.

Additionally, as an example, the apparatus for manufacturing an electrode and the method for manufacturing an electrode may be utilized to manufacture at least one of an anode and a cathode.

Additionally, as an example, at least one of the anode and the cathode may be manufactured by manufacturing an anode current collector and a cathode current collector in the form of a plate, and coating or applying the anode active material and the cathode active material on a plate-shaped current collector, respectively.

Additionally, as an example, the anode current collector plate may be formed of a material including copper, gold, stainless steel, nickel, aluminum, titanium, or alloys thereof. Additionally, as an example, the cathode current collector plate may be formed of a material including aluminum, stainless steel, nickel, titanium, copper, or alloys thereof.

For example, the anode current collector plate and the cathode current collector plate may be formed of a material including a metal such as Ni, Co, Mn, Al or Li.

Additionally, the apparatus 100 for manufacturing an electrode and the method for manufacturing an electrode may collect and reuse contaminants, electrode materials 1, and the like, collected by the dust collector 181. In some cases, a process of filtering the collected contaminants, the collected electrode materials 1, and the like, may be additionally added.

The contents described above are merely examples of applying the principles of the present disclosure, and other components may be further included or substituted and applied without departing from the scope of the present disclosure. Additionally, the above-described embodiments may be substituted or combined with each other.

What is claimed is:

1. An apparatus for manufacturing an electrode, comprising:
a hopper including an inlet into which an electrode material is input;
a support plate including a first hollow portion facing the inlet;
a partition member disposed in the first hollow portion and including a second hollow portion into which an open region of a second packaging material wrapping an outside of the first packaging material accommodating the electrode material is inserted; and
an actuator provided in the support plate, and adjusting a volume of the second hollow portion by pressurizing or depressurizing the partition member,
wherein the partition member is formed of an elastic material.

2. The apparatus for manufacturing an electrode of claim 1, wherein the actuator includes: at least one adjusting handle connected to the partition member and including a region exposed to an outside of the first hollow portion.

3. The apparatus for manufacturing an electrode of claim 2, further comprising:
at least one fixing member fixing at least a portion of the partition member to the support plate.

4. The apparatus for manufacturing an electrode of claim 2, wherein the partition member is formed of a material including a polymer.

5. The apparatus for manufacturing an electrode of claim 1, further comprising:
a sealing portion closely bringing at least a partial region of an open region of the second packaging material extending to the outside of the first hollow portion into contact with the inlet so that an end of the second packaging material is maintained in an open state.

6. The apparatus for manufacturing an electrode of claim 5, wherein the sealing portion includes:
a sealing plate into which the open region of the second packaging material is inserted, and which includes a third hollow portion facing the inlet; and
a driving member moving the sealing plate.

7. The apparatus for manufacturing an electrode of claim 6, wherein the sealing plate further includes:
at least one pressurizing projection protruding in a direction oriented toward the inlet and pressurizing the second packaging material in a direction oriented toward the inlet.

8. An apparatus for manufacturing an electrode, comprising:
a hopper including an inlet into which an electrode material is input;
a support plate including a first hollow portion facing the inlet;
a partition member disposed in the first hollow portion and including a second hollow portion into which an open region of a second packaging material wrapping an outside of a first packaging material accommodating the electrode material is inserted;
an actuator provided in the support plate, and adjusting a volume of the second hollow portion by pressurizing or depressurizing the partition member;
a sealing portion closely brining at least a partial region of an open region of the second packaging material extending to the outside of the first hollow portion into contact with the inlet so that an end of the second packaging material is maintained in an open state; and
a glove box including an accommodation space in which at least one of the inlet, the support plate or the sealing portion is accommodated, and at least one insertion slit into which the open region of the second packaging material is inserted,
wherein the partition member is formed of an elastic material.

9. The apparatus for manufacturing an electrode of claim 6, further comprising:
a glove box including an accommodation space in which at least one of the inlet, the support plate or the sealing member is accommodated, and at least one insertion slit into which the open region of the second packaging material is inserted.

10. The apparatus for manufacturing an electrode of claim 7, further comprising:
a glove box including an accommodation space in which at least one of the inlet, the support plate or the sealing portion is accommodated, and at least one insertion slit into which the open region of the second packaging material is inserted.

11. The apparatus for manufacturing an electrode of claim 8, wherein the support plate is fixed to the glove box so that the first hollow portion faces the at least one insertion slit.

12. The apparatus for manufacturing an electrode of claim 8, wherein the glove box further includes a door for opening or closing the accommodation space.

13. The apparatus for manufacturing an electrode of claim 8, further comprising:
at least one dust collecting pipe disposed in the accommodation space; and
a dust collecting pump connected to the dust collecting pipe.

14. The apparatus for manufacturing an electrode of claim 12, further comprising:
at least one fluid injection pipe in which at least one injection port is disposed in the accommodation space.

15. The apparatus for manufacturing an electrode of claim 14, wherein in the at least one fluid injection pipe, the at least one injection port is disposed adjacently to the door.

16. The apparatus for manufacturing an electrode of claim 1, wherein the hopper further includes:
a connection pipe connected to the inlet;
a storage tank connected to the connection pipe and storing the electrode material; and
a filter provided in the connection pipe.

17. The apparatus for manufacturing an electrode of claim 16, wherein the filter has magnetism and is disposed in a circumferential direction of the connection pipe.

18. A method for manufacturing an electrode by supplying an electrode material to a hopper including an inlet, comprising:
a packaging material sealing operation of opening at least a partial region of a second packaging material wrapping an outside of a first packaging material that accommodates the electrode material, and closely brining at least a partial region of an open region of the second packaging material into contact with the inlet;
a packaging material support operation of adjusting a volume of the open region of the second packaging material by pressurizing or depressurizing the open region of the second packaging material; and
a supply operation of cutting the first packaging material inside the second packaging material and supplying the electrode material to the inlet.

19. The method for manufacturing an electrode of claim 18, wherein the packaging material support operation includes:
a gripping operation of reducing a volume of the open region of the second packaging material by gripping the second packaging material with a partition member formed of an elastic material.

20. The method for manufacturing an electrode of claim 18, further comprising:
a dust collection operation of intaking a material around the inlet before performing the supply operation.
